(19) United States
(12) Patent Application Publication
(10) Pub. No.: US 2009/0251286 A1
(43) Pub. Date: Oct. 8, 2009

(54) OBJECT TRACKING DEVICES AND METHODS

(76) Inventors: Robert Black, Eagan, MN (US); Pat Geraghty, Minneapolis, MN (US); Todd Dye, Stow, OH (US); Pat Brown, Cuyahoga Falls, OH (US)

Correspondence Address: SCHWEGMAN, LUNDBERG & WOESSNER, P.A., P.O. BOX 2938, MINNEAPOLIS, MN, 55402, US

(21) Appl. No.: 12/062,376

(22) Filed: Apr. 3, 2008

(51) Int. Cl. H04Q 5/22

(52) U.S. Cl. 340/10.1

(57) ABSTRACT

This document discusses, among other things, devices and methods for tracking objects using RFID and line-of-sight techniques. In one example, an object identifier includes a tag holder. A radio frequency identification tag is on the tag holder. A reflector is on the tag holder.

### TECHNICAL FIELD

This document pertains generally to object tracking, and more particularly, but not by way of limitation, to mobile object tracking devices, systems, and methods.

### BACKGROUND

In many businesses there is a need to accurately track objects regardless of whether the objects are in a manufacturing process, packaging process, warehousing process, or delivery process. At times it is enough to track conveyances of the actual product. Some conveyances are used repeatedly, and, thus, an accurate tally of the conveyances at a given time and location is desired. Moreover to prevent loss or theft, untimely delivery, or misplacement, it is desired to continually and accurately track objects throughout the manufacturing and supply chain. Two examples of such environments are newspaper production/delivery and foodstuff production/delivery. Each of these examples requires timely delivery of products to consumers as foodstuff is perishable and the newspaper is stale if the news is not timely delivered. Moreover, newspapers target advertisement sales with a fine granularity, for example by address, zip code, or other geographic criteria. Often times, the newspaper is paid by advertisers to deliver a specific advertisement to a target consumer base. The newspapers historically track this data using manual labor for at least part of the tracking process. It is desired to automate tracking of objects.

### BRIEF DESCRIPTION OF THE DRAWINGS

In the drawings, which are not necessarily drawn to scale, like numerals may describe substantially similar components in different views. Like numerals having different letter suffixes may represent different instances of substantially similar components. The drawings illustrate generally, by way of example, but not by way of limitation, various embodiments discussed in the present document.

FIG. 1 is a schematic view of a tracking device.

FIG. 2 is a view of a radio frequency identification tag.

FIG. 3 is a view of a reflector.

FIG. 4 is a schematic view of an interrogating portal.

FIG. 5 is a schematic view of a mobile object tracking system.

FIG. 6 is a block view of mobile object tracking system.

FIG. 7 is a block view of mobile object tracking system.

FIG. 8 is a view of a mobile object loading system.

FIG. 9 is a flow chart of a method of tracking a mobile object.

FIG. 10 is a perspective view of an interrogating portal.

FIG. 11 is another perspective view of the interrogating portal of FIG. 10.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, logical and electrical changes may be made without departing from the scope of the present invention. The following detailed description is, therefore, not to be taken in a limiting sense, and the scope of the present invention is defined by the appended claims and their equivalents.

In this document, the terms “a” or “an” are used, as is common in patent documents, to include one or more than one. In this document, the term “or” is used to refer to a nonexclusive or, such that “A or B” includes “A but not B.” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

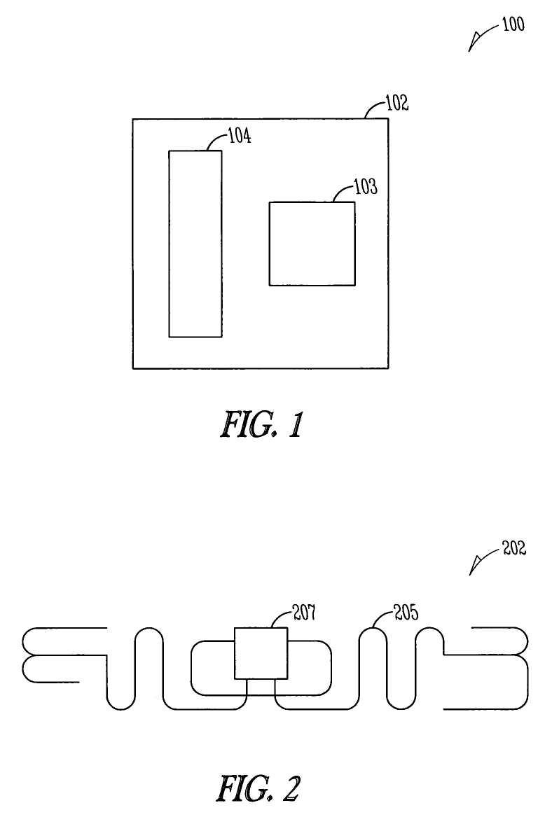

FIG. 1 shows a tracking device 100, which includes a support 102 on which is mounted a radio frequency identification (RFID) tag 104 and a reflector 103. The support 102 can include a base or housing that is adapted to be mounted to a mobile object. The support 102 can be a portion of the object to be tracked. For example, a portion of a cart or crate can be a portion of a support. In a further example, the support is a rigid housing to enclose the RFID tag 104. The reflector 103 can be mounted on the outside of the housing. The reflector 103 need not be positioned closely adjacent the RFID tag 104.

The tracking device 100 may further be a sticker transponder adapted to be affixed to a surface of an object, such as a conveyance, a vehicle, a cart, a crate, a box, etc. The transponder includes a RFID transponder enabling the storage and retrieval of data. The sticker transponder includes a flexible circuit substrate having an antenna formed thereon and a transponder circuit on the substrate. The transponder is coupled to the antenna. An adhesive layer is fixed to a first surface of the flexible circuit substrate. Optionally, an indicia layer is fixed to a second surface of the flexible circuit opposite from the first surface. The indicia layer has an area permitting indicia. In one example, the indicia are one or more Universal Product Codes (UPC) or other bar codes. The antenna has a characteristic impedance defined in part by a dielectric constant of the flexible circuit substrate in combination with a dielectric constant of the surface to which it is attached. The transponder circuit further includes a memory having a read-only portion and a re-writable portion.

FIG. 2 shows a radio frequency identification (RFID) tag 202, which includes an antenna 205 and an integrated circuit 207 operably connected to the antenna. In an example, the tag 202 is a passive device that does not have its own power source. The RFID tag 202 receives a signal from a reader, e.g., the portal described herein, on the antenna. The integrated circuit and antenna use this signal to power itself and sends out an identification signal to the reader. The antenna thus both collects power from the incoming signal and transmits the outbound signal. The RFID tag can have a size of a postage stamp to a post card. A passive RFID tag has a read distance ranging from about 10 cm, ISO 14443, up to a few meters, EPC and ISO 18000-6. The range depends on the chosen radio frequency and the design and size of the antenna. The RFID tag operates to provide automatic, contactless data capture or identification of objects using radio frequencies. By using radio frequencies, data may be captured even without a clear line of sight between the RFID tag 202 and the reader.

In an embodiment, the RFID tag operates in the electromagnetic spectrum between the frequencies of 860 MHz and 960 MHz.

In an embodiment, RFID tag includes an optical component. Unlike most other RFID tags, optical RFID operates in the electromagnetic spectrum between the frequencies of 380 THz (3.8×1014 hertz, or 708 nm) and 750 THz (7.5×1014 hertz, or 400 nm). The tag information is communicated to the reader by reflecting the read request. Some of the incoming signal is filtered by the tag and is sent back to the reader. At the reader, the tag data is analyzed by the pattern used for filtering.

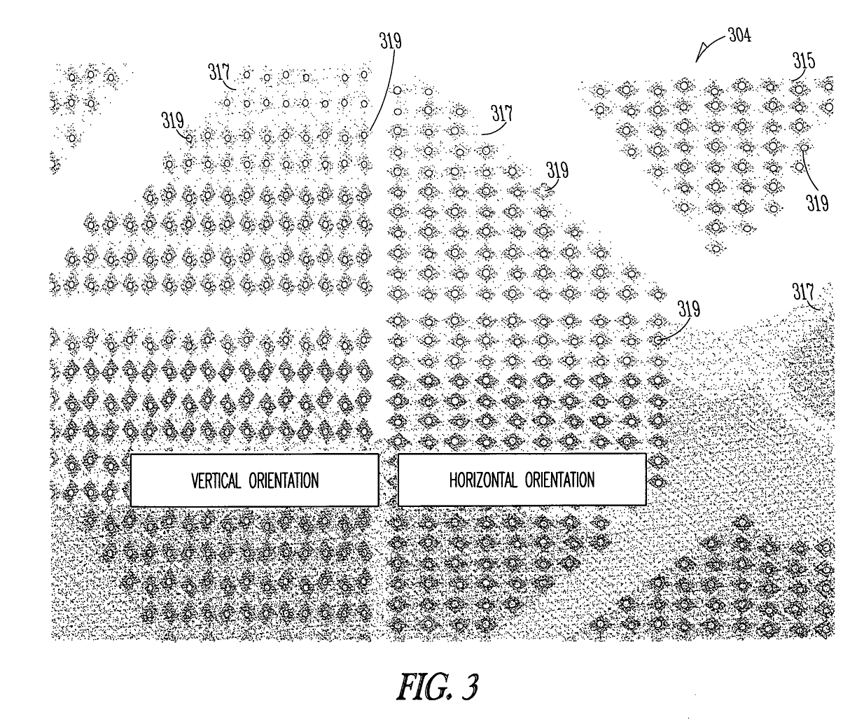

FIG. 3 shows a reflector 304, which includes a substrate and a reflective surface 315. The substrate includes an adhesive backing in an embodiment. The reflective surface 315 includes a highly retro-reflective micro prismatic markings or contours 317. These contours 317 reflect light or other electromagnetic signals from various angles. In an embodiment, the surface contours are in a diamond pattern. In an embodiment, the contours 317 are prismatic lenses that are formed in a transparent, synthetic resin, sealed and backed with a pressure-sensitive adhesive and clear poly liner (backing). As the tracking device, and hence, the reflector 304, may be used in a manufacturing or distribution environments, the performance of the reflector is not adversely impacted by toluene, #2 diesel fuel, gasoline, kerosene, TSP detergent, xylene, or similar chemicals. Additionally, the reflector 304, including its adhesive properties, is not adversely impacted by weather, i.e. temperature extremes such as cold or heat and moisture.

The surface contours 317 are oriented in a vertical reflective position and/or a horizontal reflective position. The contours 317 each have a plurality of reflective elements 319. Elements 319 have pyramid or frustoconical shape to reflect the signal at a variety of angles. In an example, the reflective surface 315 reflects a significant portion of the incident signal, for example, at least half the incident signal. The reflective surface 315 reflects at least about 80%, ±10%, at an incident signal angle between 45 and 135 degrees.

In an application of the reflector 304 to an object to be tracked or to the support 102, the reflector has a dimension of about 1½″×6″ and has at least four complete columns of contours 317. In one example, the reflector 304 is 1″ to 6″ in length. The columns can include two columns with the vertical orientation and two columns with horizontal orientation. The reflector can be an elongate, i.e., one dimension greater than a second dimension (length greater than width) strip of polarized retro-reflective tape.

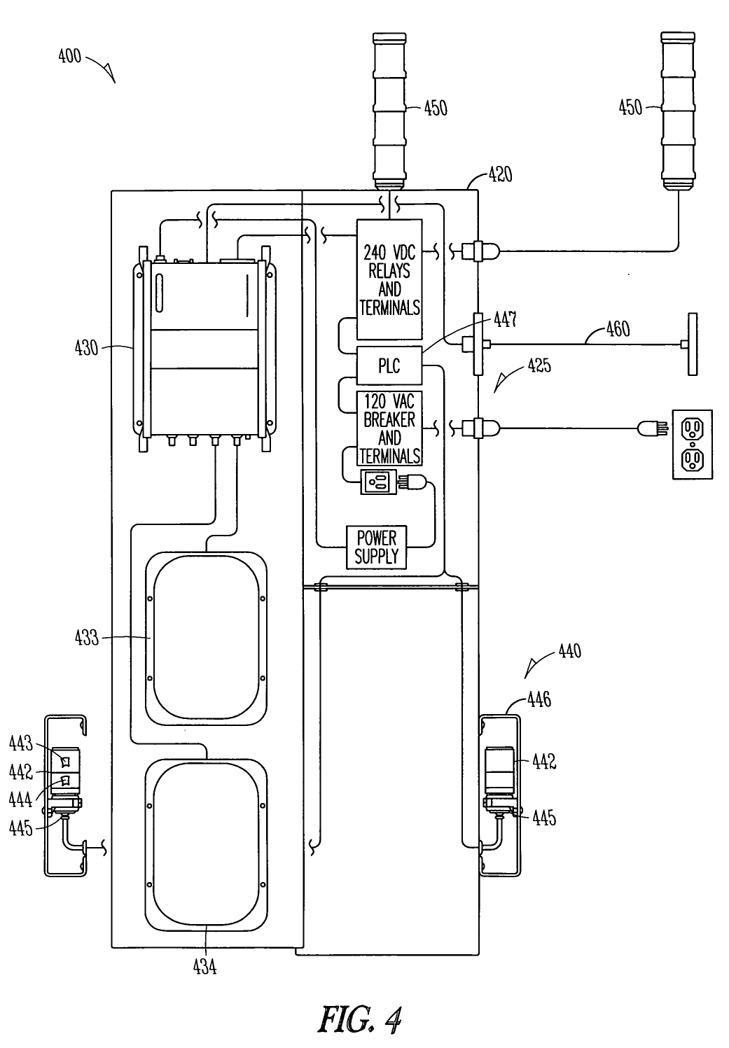

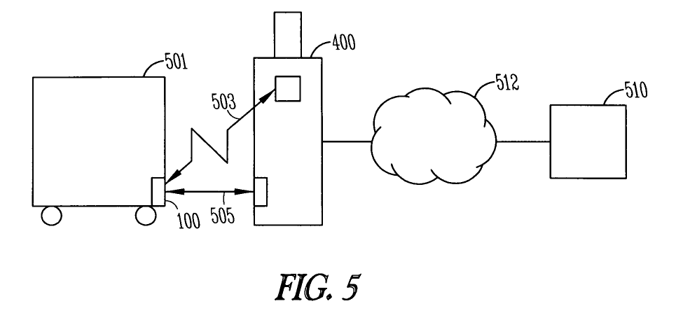

FIG. 4 shows an interrogator 400, which can be used at a specified local, e.g., an entrance exit or other flow point in the movement of objects. The interrogator 400 includes a housing 420 in which is mounted a power supply, a radio frequency control unit 430 with antennas 433, and a line-of-site unit 440. In one example, the interrogator 400 or portions thereof are height adjustable. For instance, the line-of-sight unit 440 is height adjustable to allow for objects or tracking devices 100 of varying heights. In this example, the object and/or the support 102 of the tracking device 100 includes a UPC or other bar code thereon, the height of which may vary. In order to accommodate such varying heights of the UPC or bar code, the height of the line-of-sight unit 440 of this example is adjustable.

The power supply 425 include a power source, e.g., standard grid power, a breaker and an AC to DC converter. The DC power is 24 volts in an embodiment. The DC power is fed to the radio frequency control unit 430. The control unit 430 generates and feeds a radio frequency signal to the antennas 433, 434. The antennas in turn broadcast the signal to radio frequency identification tags, e.g., 103 and 202 in FIGS. 1 and 2. The antennas 433 and 434 may be tuned to broadcast and to receive different frequencies of signals. The antenna 433 and 434 will receive a reply signal from an RFID tag in its broadcast range. The broadcast range of the RFID tag may be ten inches to ten feet. The control unit 430 receives the reply signal from the RFID tag, if a tag is within range. In an embodiment the housing further includes directional plates that shield and/or direct the radio frequency signal from the antennas 433, 434. A connect 460 is provided to connect control unit 430 to a computer system that will store the sensed data.

A line-of-site unit 440 includes two motion detectors 442. Each detector 442 includes a housing in which a photoeye assembly is housed. The assembly includes an emitter 443 and a detector 444 with associated circuitry that is connected through connector 445 to a controller 447. Controller 447 connects to control unit 430 through a relay and terminal assembly. In an embodiment, the detector 442 can be a PHOTOSWITCH™ Photoelectric Sensors, Series 9000 by Allen-Bradley.

At least one indicator 450 is mounted to the housing 420. Indicator 450 is electrically connected through relays and terminals to the control unit 430. Indicator 450 is a light stack that includes a plurality of different indicia to indicate that the interrogator is on, that it is receiving an RFID signal, that a line-of-sight signal is received, and/or that it is in communication with computerized systems. In further examples, the light stack includes signal lights to indicate that the interrogator does not (or cannot) read (or recognize) a signal, that the object is at a different location than it should be, that a signal has been read correctly, or that the interrogator is in the process of reading a signal.

FIG. 5 shows a simplified view of a system 500 for tracking objects 501 using both a radio frequency signal 503 and a line-of-sight signal 505. The radio frequency signal 503 and the signal 505 can be generated by interrogator 400. The radio signal is generated by the interrogator. The tracking device 100 on the object receives the signal and sends a signal back to the interrogator. This signal uniquely identifies the object 501. The line-of-sight signal 505 is sent from the interrogator, for example a light beam. The signal 505 reflects off the tracking device 100 and is received back at the interrogator. The interrogator 400 receives these signals and sends the received data to a computer 510 over a network 512. The network can be a global computer network, such as the internet, or a computer system of the company. In one example, the system 500 generates an exception report if unexpected data is encountered. In one example, the system 500 includes an exceptions database which is compared to data read by the interrogator 400. When the data read does not match the data within the exceptions database, the system 500 provides an exception report. For instance, if an object 501 is in the wrong location, moving in the wrong direction, or fails to arrive in the correct location, an exception report is generated. In one example, the exception report requires a user to either accept the unexpected data and proceed or remedy the unexpected data, for instance, by placing the object 501 in the correct location or moving the object 501 in the correct direction.

FIG. 6 shows a system 600 including a physical plant 601 in which mobile objects are tracked. The physical plant 601 can be a manufacturing plant, fabrication plant, newspaper production plant, or other. A plurality of production devices 605 are positioned in the plant 601. These are labeled as loaders 1 through N. Production devices 605 provide products to conveyances, such as carts, crates, boxes, etc. These conveyances can be the objects to be tracked and, hence, each includes an individual tracking device. Once loaded with appropriate product, the conveyances leave the productions devices 605. Closely adjacent the production devices 605 are interrogators 400. The interrogators 400 sense the tracking device for each object. The object is uniquely identified and sensed that it is leaving the respective production device 605. The reverse is also true. When an object with a tracking device, e.g. device 100 of FIG. 1, arrives at a production device 605, the object is identified and its arrival is also sensed. The objects leaving the production devices 605 travel in plant to any one of appropriate doors 608. When traveling through the doors 608, the object with the tracking device is again sensed by an interrogator 400 positioned adjacent the respective door. The object is uniquely identified and its direction of travel (leaving plant or arriving at plant, is also determined. In one example, the object includes two tracking devices to establish directionality when sensed by an interrogator 400.

The present system may further track the objects outside the plant. The objects are moved to distribution centers 611 from any of the doors 608. The distribution centers 611 include interrogators 400 that track the direction of travel, of each uniquely identified object. In one example, the system is a closed loop system in that the objects are returned to their point of origin in the system.

The interrogators 400 can date stamp the sensed data such the arrival and departure times of each object is known. This will assist in logistics management and tracking potential losses of goods.

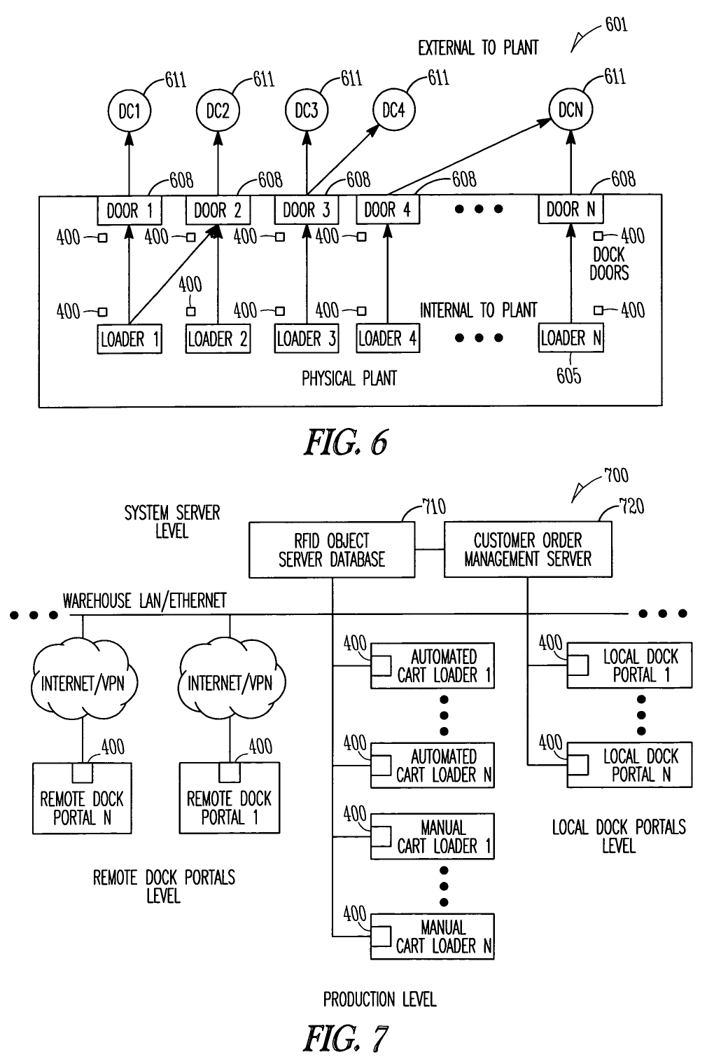

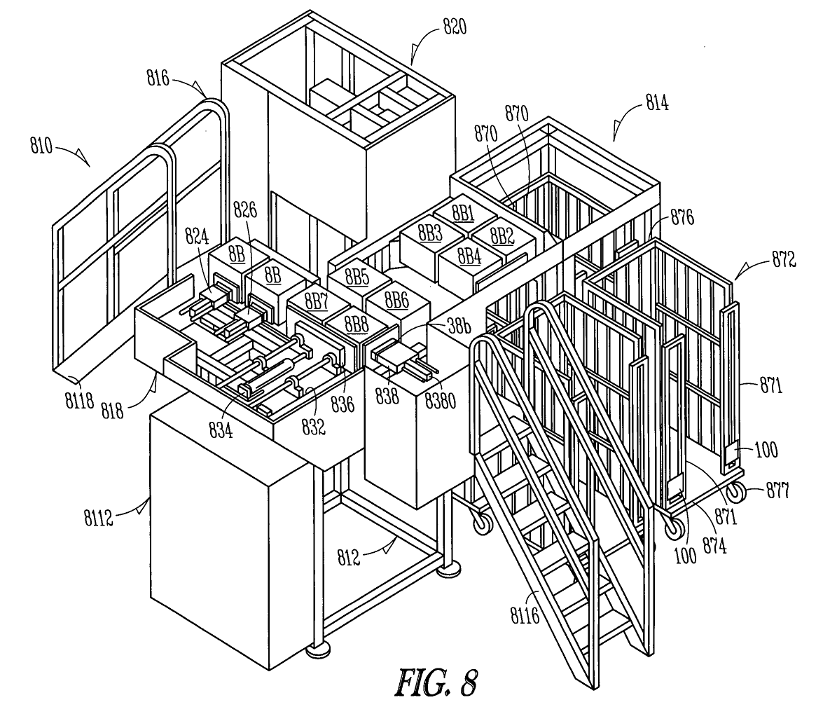

FIG. 7 shows a computer system 700 that includes a production level at which objects are filled with products, a local dock level at which the objects can leave and arrive, a remote dock level at which the objects can leave and arrive, and a system server level that includes central computer systems. Each local dock portal includes an interrogator 400 connected to a communication system. Each remote dock portal includes an interrogator 400 connected to a communication system Each production level device, such as loaders, includes an interrogator 400 connected to a communication system. The communication system can include a local area network, such as an Ethernet system. An RFID object server database 710 is connected to the communication system and receives the data sensed by all of the interrogators 400. As a result the data as to the location and movement of the object is automatically stored. This reduces the possibility of error by removing manual data entry.

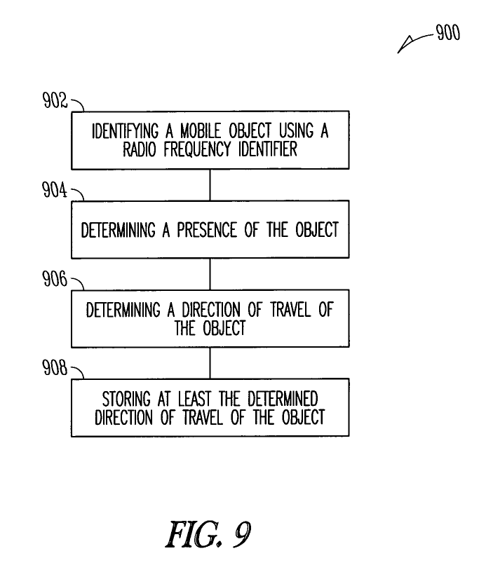

FIG. 8 shows a cart loader 810 that includes a framework 812, a cart loading station 814, an in-feed conveyor 816, a pattern forming and transporting portion 818, and a fork loading apparatus 820. A further detailed example of a cart loader is described in U.S. Pat. No. 6,572,326, titled Cart Loader And Method of Loading, which is hereby incorporated by reference for any purpose. In-feed conveyor 616 includes a continuous conveying means, such as a belt or powered roller conveyer, for moving bundles of objects 8B into transporting station 818. Clamps 824 and 826 function independently to extend and retract plates thereof to clamp bundles 8B against a rigid plate 828. In this manner clamps provide for regulating movement of bundles 8B into a first bundle position area. A bundle orientation means can be included as an optional device for orienting bundles 8B in a desired orientation. A main pusher 832 is mounted to portion 818 and includes a power cylinder 834 and pushing plate 836. A further pusher 838 is mounted at the end of conveyor and includes a cylinder 838a and a plate 838b.

Carts 872 can be of the type seen in U.S. Pat. No. 5,873,204, which application is incorporated herein by reference for any purpose. It will be understood by those of skill that rear wall channels 870 extend in a manner unimpeded by horizontal cross bracing or the like from the cart base 874 to a top channel rail 876. Base 874 includes four caster wheels 877 for providing easy portability of cart 872. As a result of no cross bracing, an individual tine can be inserted between channels 870 into the interior of cart 872 and moved continuously from a position adjacent base 874 to rail 876 without being blocked in any fashion. Carts 872 further include a plurality of tracking devices 100 mounted on respective ones of the vertical wall channels 871 and adjacent the base 874. In an embodiment, the wall channels are a support for the RFID and the reflector. In a further embodiment, the housing for at least one of the RFID and the reflector is mounted to the wall channels.

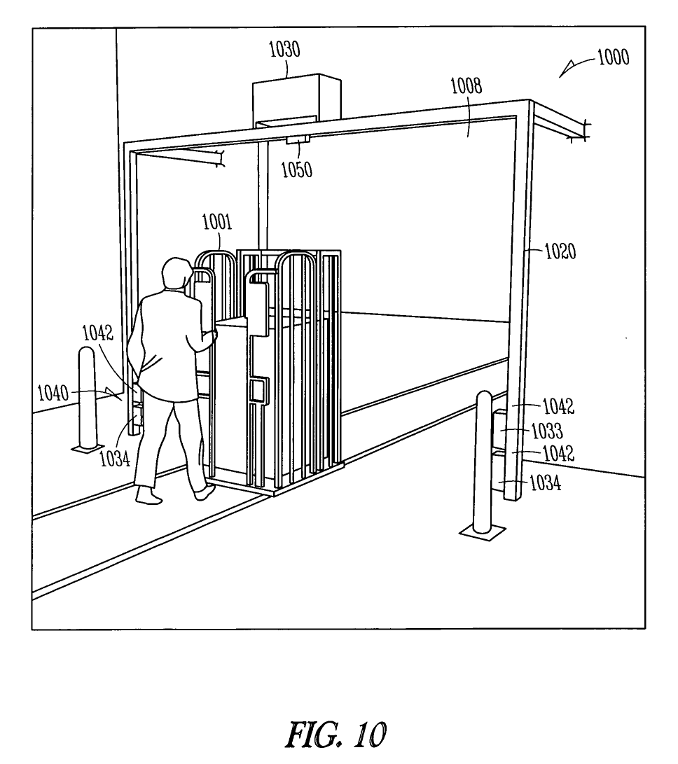

Referring to FIG. 9, there is shown an example of a method 900 of tracking a mobile object, such as the cart 872 described above and shown in FIG. 8. In other examples, the object is a pallet, a bin, or some other container. In one example, the object is identified out of a plurality of objects. At 902, a mobile object is identified using a radio frequency identifier. In one example, the radio frequency identifier is included in the tracking device 100 having a radio frequency identification tag 104 described above and shown in FIG. 1. At 904, a presence of the object is determined. At 906, a direction of travel of the object is determined. In one example, the presence and direction of travel of the object are determined by sensing of an interrogator 400 described above and shown in FIG. 7. For instance, a radio frequency identification tag of the object is interrogated at a portal, and the direction of travel of the object at the portal is essentially simultaneously determined. Such interrogators may be located at various portal locations, including, but not limited to, manual and automatic cart loaders, local and remote docks, and object transportation vehicles, such as trucks and vans. In certain examples, a first signal is reflected from the object to determine the presence of the object, and a second signal is reflected from the object to determine the direction of travel of the object. In one example, at least one of the first and second signals includes an optical signal that is reflected off a polarized retro-reflective device on the object.

At 908, at least the determined direction of travel of the object is stored. In certain examples, other information is stored, such as, but not limited to, the presence of the object in a certain location or area and contents of the object. In one example, contents of the object are correlated with the object's direction of travel and time of arrival at a portal. Contents of the object can include newspapers, magazines, flyers or circulars, mail, milk or other beverage containers, and the like. In one example, at least one of the determined presence or the determined direction of the object is evaluated and an alert is communicated if the object is in an incorrect location or traveling in an incorrect direction.

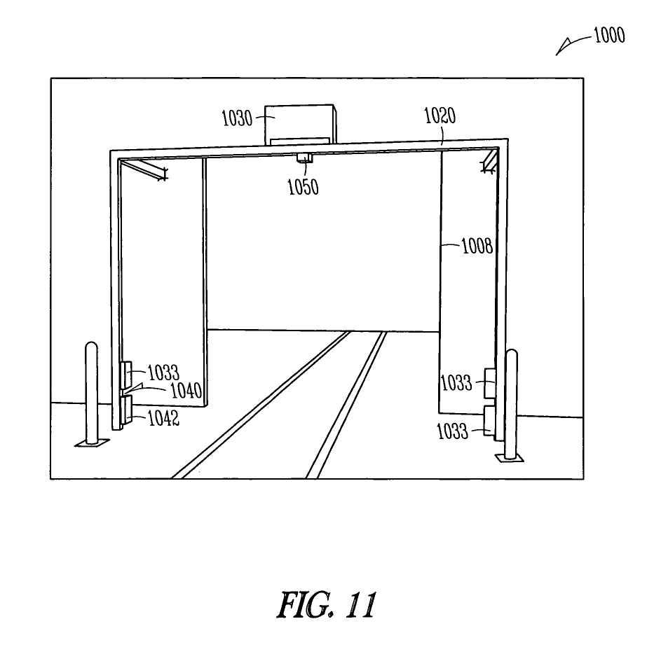

Referring to FIGS. 10 and 11, another example of an interrogator 1000 is shown. As with the interrogator 400 discussed above, the interrogator 1000 can be used at a specified local, e.g., an entrance/exit 1008 or other flow point in the movement of objects 1001. The interrogator 1000 includes a control unit 1030 having at least control electronics, a power supply, and an RFID reader disposed therein. The control unit 1030, in one example, is mounted on a frame 1020 generally above the entrance/exit 1008 or other traffic way. The frame 1020, in one example, includes portions extending generally along sides of the entrance/exit 1008 or other traffic way and include antennas 1033, 1034, and a line-of-site unit 1040 mounted thereto and disposed on either side of the entrance/exit 1008 or other traffic way. In one example, the interrogator 1000 or portions thereof are height adjustable. For instance, the line-of-sight unit 1040 is height adjustable to allow for objects 1001 or tracking devices of varying heights. In this example, the object 1001 and/or the support of the tracking device includes a UPC or other bar code thereon, the height of which may vary. In order to accommodate such varying heights of the UPC or bar code, the height of the line-of-sight unit 1040 of this example is adjustable.

The control unit 1030 generates and feeds a radio frequency signal to the antennas 1033, 1034. The antennas 1033, 1034 in turn broadcast the signal to radio frequency identification tags, e.g., 103 and 202 in FIGS. 1 and 2. The antennas 1033, 1034 may be tuned to broadcast and to receive different frequencies of signals. At least one of the antennas 1033, 1034 will receive a reply signal from an RFID tag in its broadcast range. The broadcast range of the RFID tag may be ten inches to ten feet. The control unit 1030 receives the reply signal from the RFID tag, if a tag is within range. In an example, the interrogator 1000 includes directional plates that shield and/or direct the radio frequency signal from the antennas 1033, 1034. As with the interrogator 400 discussed above, the control unit 1030 is connected to a computer system that will store the sensed data.

In this example, each line-of-site unit 1040 includes two motion detectors 1042. Each detector 1042 includes a housing in which a photoeye assembly is housed. Each assembly includes an emitter and a detector with associated circuitry that is connected to a controller. Each controller connects to the control unit 1030 through a relay and terminal assembly.

The interrogator 1000, in at least one example, includes at least one indicator 1050 mounted to the frame 1020. The indicator 1050 is electrically connected through relays and terminals to the control unit 1030. In one example, the indicator 1050 is a light stack that includes a plurality of different indicia to indicate that the interrogator 1000 is on, that it is receiving an RFID signal, that a line-of-sight signal is received, and/or that it is in communication with computerized systems. In further examples, the light stack 1050 includes signal lights to indicate that the interrogator 1000 does not (or cannot) read (or recognize) a signal, that the object 1001 is at a different location than it should be, that a signal has been read correctly, or that the interrogator 1000 is in the process of reading a signal.

Such object tracking allows for automated confirmation of shipments and deliveries and for accountability for shipments and deliveries. For instance, a shipment or delivery can be confirmed when it passes through a portal and is interrogated. Additionally, errors can be detected and corrected relatively quickly. For instance, if a particular object is identified passing through the wrong portal or traveling in the wrong direction through a portal, the error can be automatically communicated at that time. In one example, an alarm horn, buzzer, beep, or other noise sounds to alert the personnel moving the object that there is an error. A strobe light or other visual warning can be implemented in addition to or instead of the alarm horn or other noise. In yet another example, a pop-up window is presented on a display to communicate the presence of an error. This pop-up window can remain on the display until the object is removed from the wrong location or the operator overrides the error (for instance, by clicking an “Accept” button on the pop-up window).

By tracking objects in this manner, cycle time can also be improved. For instance, automatic tracking can be performed during normal movement of the objects and does not require a pause in the process to enable manual scanning or inventorying of the object. Moreover, by analyzing shipment or delivery data, opportunities for improving operational inefficiencies can be identified. Additionally, waste and scrap can be reduced with automatic object tracking. For instance, automatic tracking reduces, if not eliminates, the need for a paper trail for each shipment/delivery. Automatic object tracking also enables automated preventative maintenance.

In further examples, an object holder comprises a frame to define an object holding area, a radio frequency identification tag connected to the frame, and a reflector connected to the frame. In one example, the frame includes a rigid base and a plurality of sidewalls connected to the base. In one example, the radio frequency identification tag and the reflector are both on the sidewalls. The frame in one example is a rigid metal. In one example, the base includes wheels. In certain examples, the frame is configured to hold at least one from a group of newspaper bundles and liquid containers. In one example, the radio frequency identification tag is configured to identify the frame, and the reflector is configured to determine the direction of travel of the frame. The reflector of one example includes a polarized retro-reflective tape.

In still further examples, an object identifier system comprises a plurality of frames to define an object holding area, a radio frequency identification tag connected to one of the frames, a reflector connected to the one frame, and an interrogator to read the radio frequency identification tag to identify the one frame and to interact with the reflector to determine direction of travel of the one frame. In one example, the radio frequency identification tag is a passive device. In one example, the interrogator includes a radio frequency transmitter to excite the radio frequency identification tag, a receiver to receive a signal from the radio frequency identification tag, a non-radio frequency transmitter to send a signal to the reflector, and a non-radio frequency receiver to receive a reflected signal from a reflector in the line-of-sight. In certain examples, the non-radio frequency transmitter includes an optical transmitter, wherein the non-radio frequency receiver includes an optical receiver, and wherein the reflector is an optical reflector. The optical reflector of one example includes a polarized retro-reflective tape. In a further example, the interrogator includes a radio frequency transmitter to send a signal to the radio frequency identification tag and a receiver to receive a signal from the radio frequency identification tag. In one example, the interrogator includes a line-of-sight detector to determine direction of travel. The line-of-sight detector includes, in one example, a plurality of infra-red detectors. In one example, at least two of the radio frequency identification tags are connected to the one frame, and at least two reflectors are connected to the one frame.

Applicant further incorporates U.S. Pat. Nos. 5,873,204 and 6,572,326 by reference.

The above description is intended to be illustrative, and not restrictive. For example, the above-described embodiments (or one or more aspects thereof) may be used in combination with each other. Other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract is provided to comply with 37 C.F.R. §1.72(b), which requires that it allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment.

We claim:

1. An object identifier, comprising:
a tag holder;
a radio frequency identification tag on the tag holder; and
a reflector on the tag holder.

2. The object identifier of 1, wherein the reflector includes an optical reflector.

3. The object identifier of claim 1, wherein the reflector includes an infrared light reflector.

4. The object identifier of claim 1, wherein the reflector reflects a signal at incident angles between 45 degrees and 135 degrees.

5. The object identifier of claim 1, wherein the reflector reflects at least about 80% of a signal at an incident angle of between about 45 degrees and about 135 degrees.

6. The object identifier of claim 1, wherein the reflector includes a thin vertical strip of reflective tape on the tag holder.

7. The object identifier of claim 1, wherein the tag holder includes an enclosed interior in which the radio frequency identification tag is positioned.

8. The object identifier of claim 1, wherein the radio frequency identification tag is configured to identify a particular mobile object, and wherein the reflector is configured to determine the direction of travel of a mobile object.

9. The object identifier of claim 1, wherein the reflector includes a polarized retro-reflective device.

10. The object identifier of claim 9, wherein the polarized retro-reflective device includes a tape with an adhesive side and a reflective side.

11. The object identifier of claim 1, wherein the tag holder includes a rigid support to be attached to the object.

12. The object identifier of claim 1, wherein the tag holder is integral with a portion of the object.

13. An object identifier, comprising:
a support;
a radio frequency identification tag on the support; and
a line-of-sight identifier on the support.

14. A method for tracking a mobile object, comprising:
identifying a mobile object using a radio frequency identifier;
determining a presence of the object;
determining a direction of travel of the object;
storing at least the determined direction of travel of the object.

15. The method of claim 14, wherein identifying the object includes identifying the object out of a plurality of objects.

16. The method of claim 14, wherein determining the presence includes reflecting a first signal from the object, and wherein determining the direction includes reflecting a second signal from the object.

17. The method of claim 16, wherein reflecting a signal from the object includes reflecting an optical signal off a polarized retro-reflective device on the object.

18. The method of claim 14, wherein storing includes correlating contents of the object with its direction of travel and time of arrival at a portal.

19. The method of claim 14, wherein identifying the object includes interrogating at a portal a radio frequency identification tag of the object, and essentially simultaneously determining the direction of travel of the object at the portal.

20. The method of claim 14, comprising evaluating at least one of the determined presence or the determined direction of the object and communicating an alert if the object is in an incorrect location or traveling in an incorrect direction.
